(19) United States
(12) Patent Application Publication
(10) Pub. No.: US 2006/0064734 A1
(43) Pub. Date: Mar. 23, 2006

(54) Portable device for viewing real-time synchronized information from broadcasting sources

(76) Inventor: Yue Ma, West Windsor, NJ (US)

Correspondence Address: GREGORY A. STOBBS, 5445 CORPORATE DRIVE, SUITE 400, TROY, MI, 48098, US

(21) Appl. No.: 10/535,996

(22) PCT Filed: Dec. 2, 2003
(86) PCT No.: PCT/US03/38286

§ 371 Date: May 24, 2005

Related U.S. Application Data
(60) Provisional application No. 60/430,292, filed on Dec. 2, 2002.

(51) Int. Cl. H04N 7/16

(52) U.S. Cl. 725/136

(57) ABSTRACT

A broadcast media viewing system includes a source of a broadcast stream including primary data providing primary media content and supplemental data providing supplemental information. A media content viewing mechanism decodes the primary data and renders the primary media content to a first active display. A portable device decodes the supplemental data and renders the supplemental information to a second active display.

### FIELD OF THE INVENTION

The present invention generally relates to interactive television and seamless integration of information from disparate sources, and particularly relates to a portable device receiving and processing supplementary data associated with a television broadcast signal to provide users with a uniform and consistent interface.

### BACKGROUND OF THE INVENTION

In television (TV) broadcast, supplementary information (e.g. EPG, advertisement URL, etc.) is typically embedded as supplemental data into a broadcast stream of primary media content so that consumers can simultaneously receive both the primary media content and the supplemental information. Thus, a broadcast stream includes primary data (A/V) and supplemental data. Normally, methods are implemented inside a set-top box (STB) to decode and process these sets of information, and supplementary information is overlaid on the main TV screen. The resulting display is undesirable from the perspective of the consumer, because the overlaid information on the active display of the TV obstructs the main view of primary media content. Therefore, a viewer causing the supplemental data to overlay the presentation of the primary media content disturbs other viewers watching the primary media content. In addition, the need for a STB causes the consumer to incur substantial cost.

Since supplementary information to a TV program may reside at disparate sources (e.g. Internet, broadcast channel, external storage, etc.), presentation of primary media content and presentation of supplemental information needs to be synchronized in order to deliver a uniform package of contents to the user. Simple synchronization methods such as based on “time” and “channel” are not reliable because TV program schedules may change without notice. TV advertisements, in particular, usually do not have accurate schedules.

The need remains for a system that enhances the viewing of TV using a portable device that provides a second screen for viewing supplementary information, but does not requiring installation of a STB. The need further remains for a reliable synchronization method that is based on actual contents of the broadcast signal. The present invention fulfills these needs.

### SUMMARY OF THE INVENTION

In accordance with the present invention, a broadcast media viewing system includes a source of a broadcast stream including primary data providing primary media content and supplemental data providing supplemental information. A media content viewing mechanism decodes the primary data and renders the primary media content to a first active display. A portable device decodes the supplemental data and renders the supplemental information to a second active display.

The broadcast media viewing system and portable device of the present invention is advantageous over previous broadcast media viewing systems in that a self contained integrated environment/system is provided without need of an expensive server or STB. It further provides a guaranteed real-time synchronization with ongoing TV programs with an integrated environment (TV to device direct capturing without delay) and content-based synchronization scheme. The system can be used for both digital and analog systems, and can be applied in various configurations of the TV system.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of a media content viewing system according to the prior art;

FIG. 2 is a block diagram of a media content viewing system according to the present invention;

FIG. 3 is a block diagram of a first embodiment of a portable device according to the present invention;

FIG. 4 is a block diagram depicting synchronization of information from disparate sources according to the present invention;

FIG. 5 is a block diagram of a second embodiment of a portable device according to the present invention; and

FIG. 6 is a block diagram of a third embodiment of a portable device according to the present invention.

### DETAILED DESCRIPTION OF THE PREFERRED EMBODIMENTS

The following description of the preferred embodiment(s) is merely exemplary in nature and is in no way intended to limit the invention, its application, or uses.

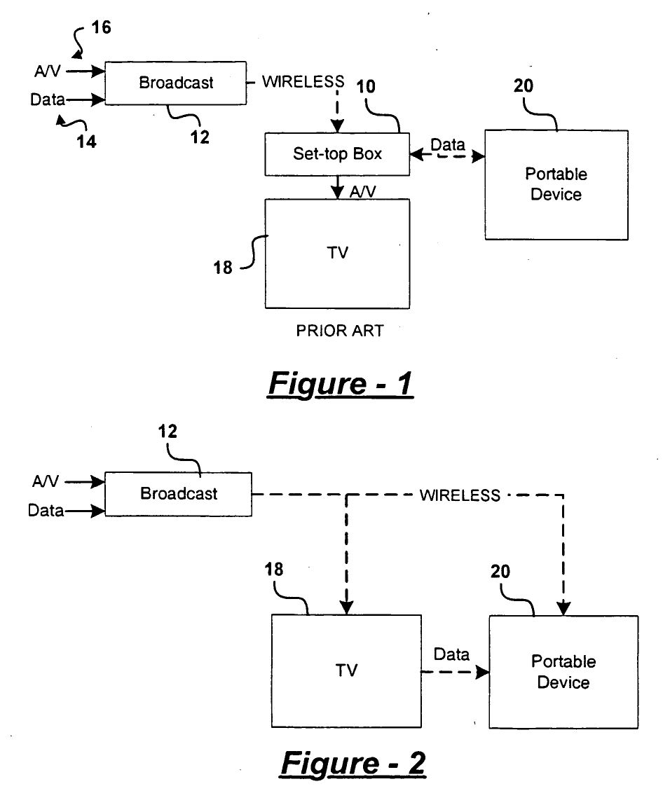

The present invention provides a portable device for receiving supplementary information from a TV broadcast stream, and for synchronizing communication of the supplementary information with communication of the primary media content on the device or other disparate data sources. The present invention particularly differs from the prior art, as shown in FIG. 1, in that it does not employ a STB 10 to receive the broadcast signal from broadcast source 12, separate the supplemental data 14 from the primary data 16, and separately communicate the primary data and supplemental data to media content viewing mechanism 18 and portable device 20, respectively.

According to the present invention as shown in FIG. 2, the portable device 20 instead receives the broadcast signal from the broadcast source 12, and/or acquires the data from media content viewing mechanism 18 by sensing the data embedded in video images displayed on an active display of media content viewing mechanism 18. Portable device 20, in accordance with the present invention, is therefore adapted to decode and process the broadcast signal to extract the supplemental data, and/or adapted to extract supplemental data from video images using a photo sensor. In further operation, portable device 20 according to the present invention is adapted to intermittently decode primary data and render a portion of primary media content to an active display of portable device 20.

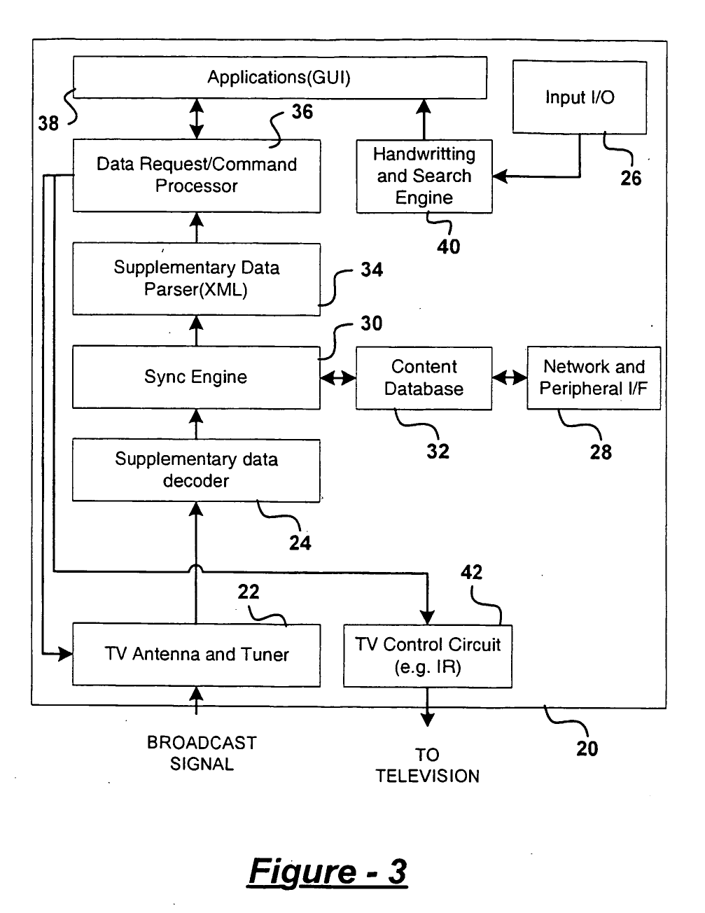

In a first embodiment shown in FIG. 3, the portable device includes an active display (LCD, etc.), TV tuner 22 and channel selection mechanism, a decoder 24, user input 26 (touch screen, stylus, keyboard, etc.), battery, memory, network interface and other I/O peripherals 28. In operation, portable device 20 receives the broadcast signal via TV tuner 22. The broadcast signal is organized into a plurality of channels, wherein a channel has corresponding supplemental data embedded in the primary data of the channel. TV tuner 22 is used to receive the broadcast signal and tune to the user selected channel, and supplementary data decoder 24 decodes the supplemental data embedded in the selected channel of the broadcast signal. Notably, supplementary data decoder 24 is used to decode only supplementary data from the broadcast signal, and ignores the primary A/V signal. This type of function can be accomplished for both analog (VBI, VEIL or QAM) and digital signals (MPEG).

Sync engine 30 accesses content database 32, which is used to buffer and store contents from real-time TV and other disparate sources. Sync engine 30 is designed to deliver a consistent package of contents based on the real-time content from TV broadcast and what is available in the content database. Optionally, sync engine 30 can also request needed information for other network interface and other I/O peripherals 28. Supplementary data parser 34 parses extracted supplemental information based on metadata tags (XML) or other identifying information provided to the supplemental information. Data request/command processor 36 then presents the parsed supplemental information to the viewer via Graphic User Interface (GUI) components of software applications 38.

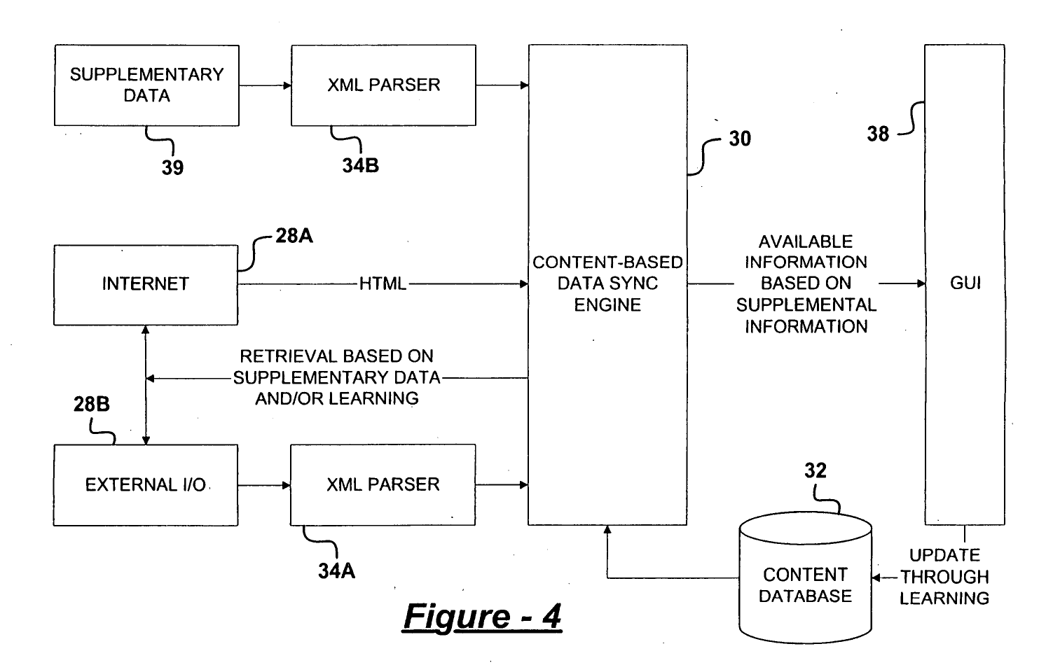

The synchronization technique of FIG. 4 particularly differs from the prior art in that it does not embed URL in supplementary data 39, and thus does not require that the URL to be referred be pre-specified. Instead, the present invention realizes that information can also exist on Internet 28A and/or external I/O devices 28B, and that these locations are unknown when the supplementary contents are authorized at broadcasting head-end. Therefore, supplementary data 39 embeds the information about its contents through XML based tags instead of URL. XML parser 34B serves to assist in this function. External I/O devices 28B store other, related information that can be retrieved and presented to the user in sync with supplementary data, and XML parser 34A serves to assist in this function. Further, Internet 28A can be used to retrieve other related and synchronized information. Related information can still further be obtained by Internet 28A and/or external I/O devices 28B based on most recently extracted supplementary data 39 and/or a priori knowledge relating to what channel the user currently watching.

In addition, content database 32 buffers supplementary data 39 and related information as well as pre-retrieved supplementary data and related information, where pre-retrieved supplementary data has been selected to store according to the system and user behaviors through learning. The contents of content database 32 are thus frequently updated through this learning process. Related information can thus still further be obtained from pre-stored contents of content database 32 based on most recently extracted supplementary data 39 and/or a priori knowledge relating to what channel the user is currently watching. As a result, a user can retrieve, store, and/or edit available information that is based on the supplemental information, wherein the supplemental information includes supplemental data extracted from the broadcast signal, and/or related information obtained by Internet 28A, by external I/O devices 28B, and/or from content database 32.

The user can operate the portable device 20 (FIG. 3) and the TV by inputting commands via user interface 26 and handwriting and search engine 40. Processor 36 controls TV tuner 22 and TV control circuit 42 based on user input to cause the TV and portable device to simultaneously tune to identical channels of the broadcast signal. Data request/command processor 36 further allows the user to select to perform other TV control functions (e.g. volume etc.). The supplementary data decoder 24 and the sync engine 30 thus interact to deliver a uniform package of contents based on the contents of the supplementary information. From the user's perspective, it is only necessary to tune to a channel and supplementary information associated with an ongoing TV program is shown on the active display of the portable device. The user can manipulate downloaded supplementary information by editing it, deleting unwanted sections of it, or saving it. The portable device 20 according to the present invention can function with analog broadcast (such as VBI) and/or digital broadcast (e.g. MPEG decoding).

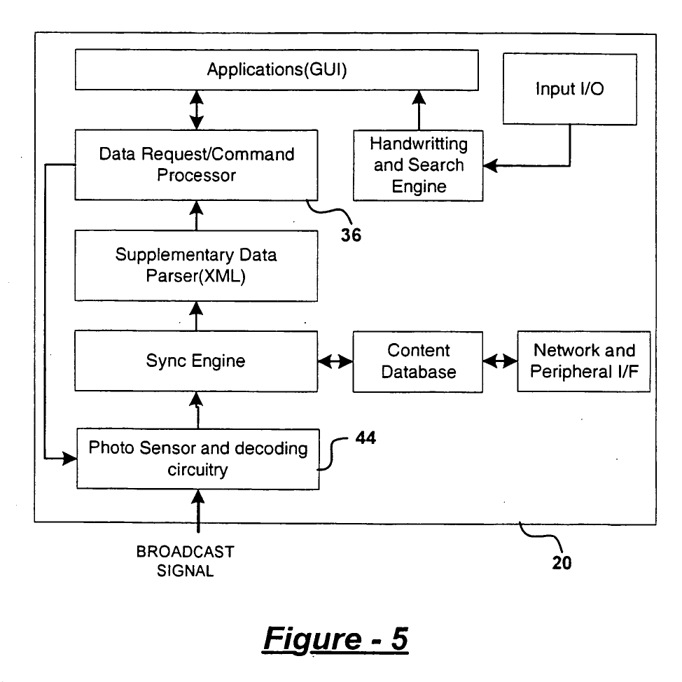

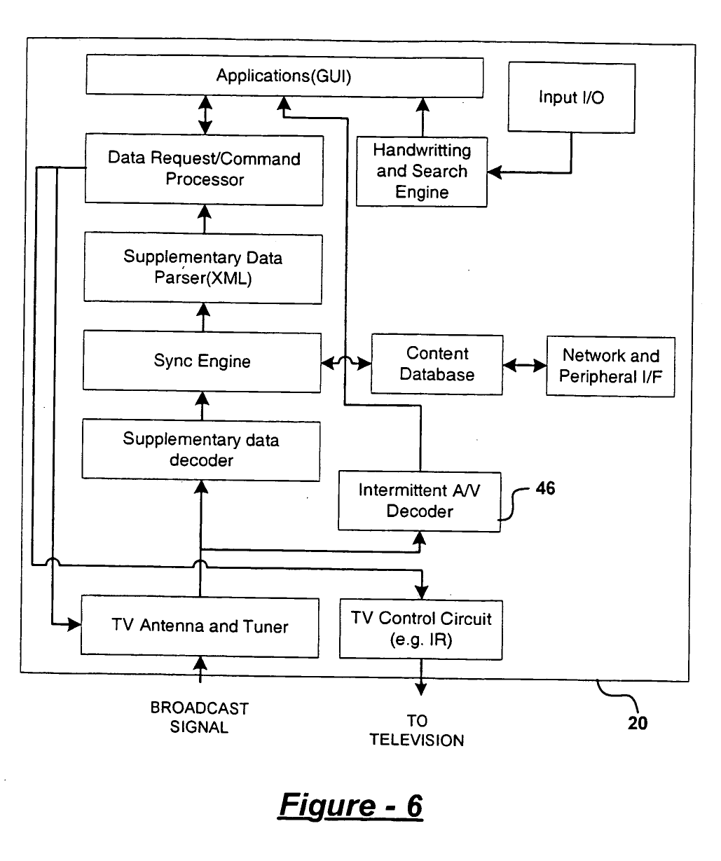

A second embodiment illustrated in FIG. 5 is similar to the first embodiment, except portable device 20 does not use a TV tuner/decoder. Instead, it has a photo sensor and decoding circuitry 44 operable to sense optical signals transmitted from the TV, and to decode embedded data from optical images. With this device, the user does not need to tune to the TV channel first. Instead, the user can simply point the photo sensor toward the TV screen and receive supplementary information that is embedded in video images displayed thereon. Technologies such as VEIL optical data encoding/decoding can be utilized for this purpose. The photo sensor 44 can operate with analog and/or digital images. Data request/command processor 36 allows the user to issue a “capture” command, and the photo sensor/circuitry 44 starts capturing supplemental data embedded in images displayed on the TV screen.

A third embodiment illustrated in FIG. 6 is essentially an enhancement of one or more of the first and second embodiments. The third embodiment is a portable device 20 with the addition of an intermittent A/V decoder 46. The intermittent A/V decoder decodes primary data to extract A/V contents from the broadcast stream at specified frame intervals, and renders the A/V contents on the active display of the portable device 20 at reduced resolution. With this portable device 20, when the user downloads supplementary information, a frame shot is displayed on the device's display to reflect user interaction with a current channel and/or media content. The intermittent A/V decoder 46 is designed to save power and CPU resource on the portable device 20 in comparison to a full-fledged tuner, but a frame shot that updates at specified intervals is sufficient to give a user a view of ongoing TV contents.

In accordance with various embodiments, the primary media content may be extracted intermittently or continuously, and may therefore be rendered on the second active display of the portable device at full resolution or reduced resolution. The extracted primary media content thus rendered may be used in various ways. For example, the user may channel surf while viewing only the second active display. Also, the user may simultaneously view the current channel and electronic programming guide contents on the second active display. Further, the intermittent or continuous primary media content decoder may be adapted to extract primary media content of a currently selected channel of the primary media consumption device, such as a television, or a currently selected channel of an electronic programming guide accessed by the portable device. Still further, the portable device may be adapted to automatically switch between decoding primary media content co-displayed on the television, and decoding user selected channels of an electronic programming guide. Thus, the portable device may automatically co-display primary media content during channel surfing, while independently displaying alternate primary media content of another channel of interest to the user based on user access of an electronic program guide via the portable device. In addition, the user may be allowed to selectively disable the co-display during channel surfing, and surf alternate channels using only the portable device or only the television at the user's option. Supplemental content may therefore be extracted from either or both channels thus simultaneously viewed by the user.

The description of the invention is merely exemplary in nature and, thus, variations that do not depart from the gist of the invention are intended to be within the scope of the invention. For example, various embodiments of the present invention may be combined to accomplish, for example, a portable device receiving the broadcast signal, extracting the supplemental information, and using a photo sensor and decoding circuitry to identify the appropriate channel and control the tuner. Also, the decoder of the portable device may operate to fully decode A/V signals as well as supplemental data, thereby enabling display of the primary media content on the portable device at high resolution. In general, the precise implementation of the present invention can vary according to available technology and prevailing market forces. Such variations are not to be regarded as a departure from the spirit and scope of the invention.

1. A broadcast media viewing system, comprising:
a source of a broadcast stream including primary data providing primary media content and supplemental data providing supplemental information;
a media content viewing mechanism decoding the primary data and rendering the primary media content to a first active display;
a portable device decoding the supplemental data and rendering the supplemental information to a second active display;
wherein the portable device receives the broadcast stream simultaneously received by the media content viewing mechanism, said portable device and media content viewing mechanism each having tuners capable of independently tuning to different channels of the broadcast stream.

2. The system of claim 1, wherein the primary media content rendered to the first active display comprises images having supplemental data embedded therein, and wherein said portable device senses and decodes the supplemental data embedded in the images.

3. The system of claim 1, wherein said broadcast stream is organized into a plurality of channels, wherein a channel has corresponding supplemental data embedded in the primary data of the channel, said media content viewing mechanism has a first tuner receiving a selected channel of the broadcast signal, and said portable device has a second tuner receiving a selected channel of the broadcast signal.

4. The system of claim 1, wherein said portable device, in response to user input, is operable to designate the selected channel for the first tuner and the second tuner.

5. The system of claim 1, wherein said portable device further comprises:
a content database adapted to buffer and store supplemental information from a source of supplemental information; and
a sync engine adapted to deliver a consistent package of contents based on decoded supplemental data and contents of the content database.

6. The system of claim 1, wherein said portable device further comprises an intermittent primary media content decoder adapted to decode primary data to extract primary media content at predetermined frame intervals, and to render the primary media content to the second active display at reduced resolution.

7. The system of claim 1, wherein said portable device further comprises a primary media content decoder adapted to decode primary data to extract primary media content, and to render the primary media content to the second active display.

8. The system of claim 7, wherein said portable device is adapted to render the primary media content to the second active display in combination with supplementary media content including contents of an electronic programming guide.

9. The system of claim 8, wherein the primary media content decoder is adapted to selectively decode channels based on user access of the contents of the electronic programming guide.

10. The system of claim 7, wherein said primary media content decoder is adapted to decode a channel selected for display on the first active display of said media content viewing mechanism, thereby accomplishing co-display of the primary media content during a channel surfing activity.

11. The system of claim 7, wherein said primary media content decoder is adapted to decode a channel regardless of a channel selected for display on the first active display of said media content viewing mechanism, thereby allowing the user to view two channels simultaneously during a channel surfing activity.

12. A portable device for use with a broadcast media viewing system, comprising:
a first tuner receiving a selected channel of a broadcast stream, wherein the channel includes primary data providing primary media content and supplemental data providing supplemental information;
a supplemental decoder decoding the supplemental data to extract the supplemental information;
a first active display communicating the supplemental information to a user; and
a command processor independently designating selected channels for said first tuner and for a media content viewing mechanism having a second tuner receiving an independently selected channel of the broadcast stream, wherein said media content viewing mechanism is operable to decode the primary data and render the primary media content to a second active display.

13. The device of claim 12, further comprising an intermittent primary media content decoder adapted to decode primary data to extract primary media content at predetermined frame intervals, and to render the primary media content to the first active display at reduced resolution.

14. The device of claim 12, further comprising:
a content database adapted to buffer and store supplemental information from a source of supplemental information; and
a sync engine adapted to deliver a consistent package of contents based on decoded supplemental data and contents of the content database.

15-17. (canceled)

18. A synchronization method for use with a media content viewing system, comprising:
tuning to a first channel of a television broadcast being enjoyed by a user independently of a second channel being enjoyed by the user;
decoding supplemental data embedded in a television broadcast being enjoyed by a user;
retrieving related information based on the supplemental data from a source of related information;
buffering and storing the supplemental data and related information as supplemental information in a content database; and
delivering a consistent package of contents based on the decoded supplemental data and contents of the content database.

19. The method of claim 18, further comprising:
intermittently decoding primary data of the television broadcast, thereby obtaining primary media content; and
visually rendering the primary media content at reduced resolution.

20. The method of claim 18, further comprising:
decoding primary data of the television broadcast, thereby obtaining primary media content; and
visually rendering the primary media content.

21. The method of claim 20, further comprising rendering the primary media content in combination with supplementary media content including contents of an electronic programming guide.

22. The method of claim 21, further comprising:
remotely controlling a peripheral media consumption device to display primary media content of a user selected channel of the broadcast; and
selectively decoding channels independently of user selection of the user selected channel based on user access of the contents of the electronic programming guide.

23. The method of claim 20, further comprising:
remotely controlling a peripheral media consumption device to display primary media content of a user selected channel of the broadcast; and
decoding a channel selected for display on peripheral media consumption device, thereby accomplishing co-display of the primary media content during a channel surfing activity.

24. The method of claim 20, further comprising:
remotely controlling a peripheral media consumption device to display primary media content of a user selected channel of the broadcast; and
decoding a channel regardless of a channel selected for display by the peripheral media consumption device, thereby allowing the user to view two channels simultaneously during a channel surfing activity.

25. The method of claim 18, further comprising:
generating metadata tags adapted to identify supplementary media content accessible to users;
embedding the metadata tags in a broadcast signal containing primary media content related to the supplementary media content; and
broadcasting the signal to the users.

26. The method of claim 25, wherein the metadata tags are XML tags.

27. A synchronization method for use with a media content viewing system, comprising:
generating metadata tags adapted to identify supplementary media content accessible to users;
embedding the metadata tags in a broadcast signal containing primary media content related to the supplementary media content; and
broadcasting the signal to the users.

28. The system according to claim 1, wherein said portable device is adapted to retrieve related information based on the supplemental data from a source of related information, to buffer and store the supplemental data and related information as supplemental information in a content database, and to deliver a consistent package of contents based on the decoded supplemental data and contents of the content database.

29. The device according to claim 12, further comprising:
a source of related information delivering related information based on the supplemental data;
a content database buffering and storing the supplemental data and related information as supplemental information; and
a synchronization engine delivering a consistent package of contents based on the decoded supplemental data and contents of the content database.
